(19) United States
(12) Patent Application Publication
(10) Pub. No.: US 2005/0066503 A1
(43) Pub. Date: Mar. 31, 2005

(54) Rack for vehicle lift

(76) Inventor: Stephen Holbein, Shirley, MA (US)

Correspondence Address: Lambert & Associates, P.L.L.C., 92 State Street, Boston, MA, 02109-2004, US

(21) Appl. No.: 10/671,014

(22) Filed: Sep. 25, 2003

(51) Int. Cl. B23P 19/00

(52) U.S. Cl. 29/426.1; 269/47

(57) ABSTRACT

The present invention rack for vehicle lift, includes a hanging member and support, that may be comprised of two opposing L-shaped supports, secured by a constricting mechanism, such as two flathead screws, to a vehicle lift allowing for the suspension of detached vehicle components. Therefore, when the lift is ascended, an individual may detach vehicle components placing them onto the apparatus and reattach them with minimal lifting and bending. Furthermore, the L-shaped supports are easily removed from the vehicle lift after the completion of work on a vehicle preventing any accidents that may occur.

### FIELD OF THE INVENTION

The present invention relates generally to the field of vehicle maintenance and repair and specifically to a rack for vehicle lift for supporting vehicle components such as tires during vehicle maintenance and repair.

### BACKGROUND OF THE INVENTION

During vehicle repair or maintenance, it is often necessary for a vehicle to be elevated by a lift in order to gain access to vehicle components located underneath the vehicle. Routine maintenance and repair such as brake-jobs, tire rotation and axle replacement require removal of vehicle tires and other vehicle components. Vehicle components such as tires are relatively heavy and can weigh over 80 pounds. Customarily, the components are placed on the ground after removal causing the individual to lift and bend with heavy weight. Due to the weight of vehicle components, individuals may incur serious back strain and other injuries caused by bending and lifting during vehicle repair. Further, placing components such as wheels on the ground can tend to dent or ruin the finish of such components. Therefore, a mechanism is needed for retaining tires and other vehicle components during repair and maintenance.

Published Patent Application US 2003/0080270 by Gibson et al. discloses an apparatus that may be secured to a vehicle lift in order to hold tires while detached from an elevated vehicle. However, numerous components and screws cause the apparatus in Gibson et al. to be relatively heavy and expensive. Furthermore, the various components prevent users from easily transporting and utilizing the invention in multiple locations. The invention disclosed in Gibson et al. restricts the entire perimeter of the lift support precluding compatibility with many different sized hoists and other support structures. The component included in Gibson et al. that retains the tire while detached from a vehicle is cylindrical in shape allowing the tire to move and spin freely. Various other methods for storing vehicle components during maintenance and repair such as separate lifts are relatively expensive and difficult to transport for use in other locations.

What is needed is an economical and relatively light rack for a vehicle lift, compatible with many different sized hoists and other support structures, comprised of few components for easy adjustment and transportation in multiple locations.

### SUMMARY OF THE INVENTION

The present invention rack for vehicle lift, includes a hanging member and support, that may be comprised of two opposing L-shaped supports, secured by a constricting mechanism, such as two flathead screws, to a vehicle lift allowing for the suspension of detached vehicle components. Therefore, when the lift is ascended, an individual may detach vehicle components placing them onto the apparatus and reattach them with minimal lifting and bending.

The limited amount of apparatus components allows the apparatus to be economical. Therefore, a plurality of apparatuses may be employed in order to retain multiple automotive components. In the case of tire rotation, four apparatuses may be positioned in different locations on the vehicle lift retaining all four vehicle tires.

The apparatus is installed and removed, in one embodiment, by simply loosening and tightening two flathead screws allowing the transportation of the apparatus to be timely and simple. Additionally, the apparatus is composed of minimal components allowing the weight to be relatively light. Therefore, due to the ease and lightweight of the apparatus, the apparatus may be moved to different locations during automotive maintenance or repair. If only one individual is rotating tires, the individual may move the apparatus to the four different tire locations as needed.

In the preferred embodiment, the L-shaped supports are secured around only three sides of the vehicle lift, and the distance between the L-shaped supports may be easily adjusted. Consequently, the apparatus may be used with many different vehicle lift configurations.

The present invention may also include a stopper at the end of the hanging member. The stopper helps to retain and stabilize detached components.

These and other features, aspects and advantages of the present invention will become better understood with reference to the following description, claims, and accompanying drawings. Therefore, the form of the invention, as set out above, should be considered illustrative and not as limiting the scope of the following claims.

### BRIEF DESCRIPTION OF THE DRAWINGS

FIG. 1 is a side view of an embodiment of a rack for vehicle lift;

FIG. 2 is a perspective view of the present invention disposed on a vehicle lift; and

FIG. 3 is a side view of the present invention disposed on a vehicle lift supporting a vehicle tire.

### DETAILED DESCRIPTION OF THE PREFERRED EMBODIMENT

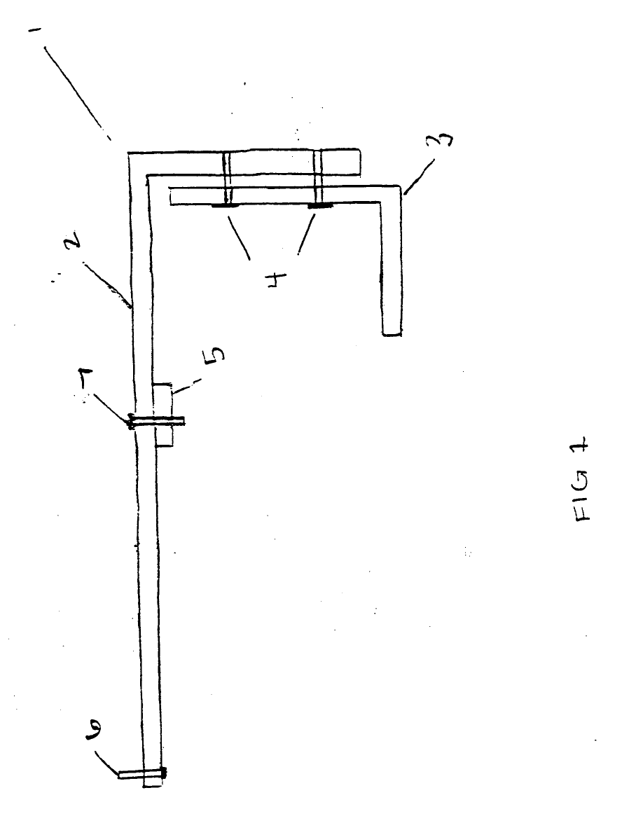

The preferred embodiment for the present invention is shown in FIGS. 1-3. The apparatus 1 of the present invention comprises a first L-shaped support 2 having a vertical segment and a horizontal segment, comprised of one piece of material, securing around the top and side surfaces of the vehicle lift. A second L-shaped support 3 having a vertical segment and a horizontal segment, composed of one piece of material, is positioned to oppose the first L-shaped support 2 securing around the bottom and side portions of the vehicle lift. The vertical segment of the second L-shaped support 3 is placed inside of the vertical segment of the first L-shaped support 2 and secured together by two screws 4. The screws 4 may be any screw of high strength material, however, in order to allow the second L-shaped support 3 to be flush against the vehicle lift, it is preferred that the screws 4 are of the flathead variety. The distance between the first L-shaped support 2 and second L-shaped support 3 may be adjusted by slides, or other adjustable means, integrated within the vertical segments of the L-shaped supports 2, 3 and locked into position by the screws 4. The horizontal segment of the first L-shaped support 2 extends beyond the top surface of the vehicle lift in order to support the detached vehicle components such as tires. In order to further support the apparatus when secured to the vehicle lift, a block 5 is secured by a screw 7 to the bottom surface of the extended horizontal segment of the first L-shaped support 2 decreasing the bending moment. The detached vehicle components are retained by a stopper 6 located at the end of the top surface of the horizontal segment of the first L-shaped support 2. Therefore, when the lift is ascended, an individual may detach vehicle components placing them onto the apparatus 1 and reattach them with minimal lifting and bending.

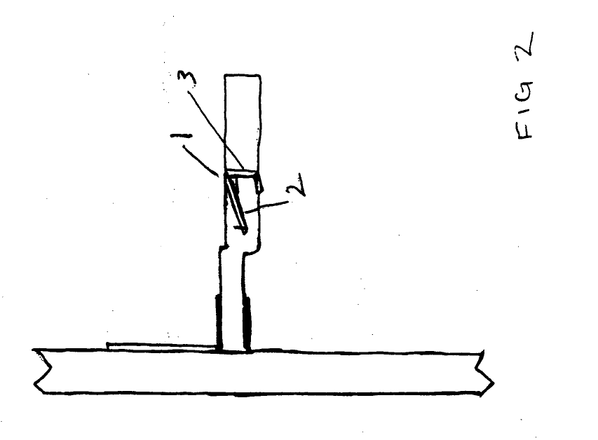

FIG. 2 illustrates one position that the apparatus 1 may be secured on a vehicle lift and in no way limits the available positions. The first L-shaped support 2 is visible over the top surface of the vehicle lift. The second L-shaped support 3 that secures to the bottom and side surfaces of the vehicle lift is shown in broken lines; however, it would be obscured from view by the vehicle lift.

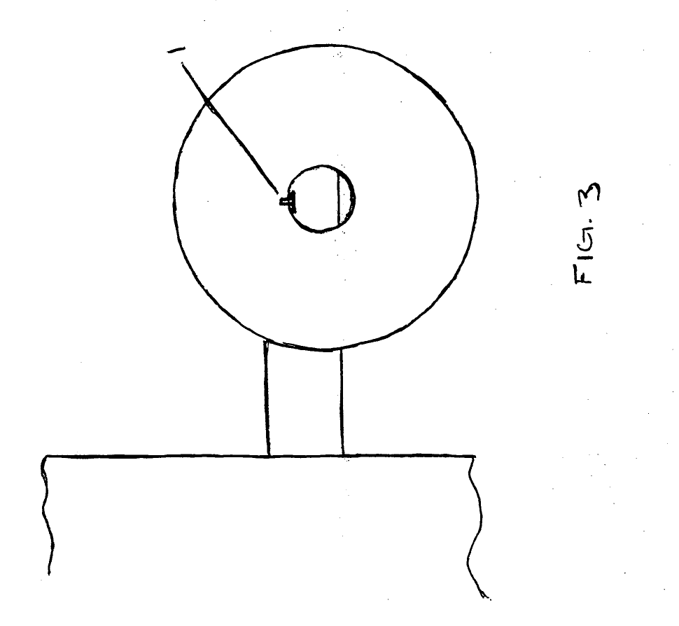

FIG. 3 illustrates the apparatus 1 in use to retain a tire, however, the apparatus 1 may be used for any component able to hang. The horizontal member of the first L-shaped support 2 extends beyond the top surface of the vehicle lift through the center opening of the tire allowing an vehicle component, a tire, to hang.

The screws 4 that attach and adjust the L-shaped supports 2, 3 may be of any dimension depending on the desired size of the apparatus 1. An apparatus 1 capable of retaining one vehicle tire typically uses ¼−20×1¼″ flathead screws in conjunction with wing nuts and multiple flat washers.

The L-shaped supports 2, 3 may be composed of any high strength material such as steel. The first L-shaped support 2 capable of retaining one vehicle tire has typical dimensions of ¼″ thickness, 1½″ width and 24″ overall length.

The block 5 may be comprised of any high strength material such as steel or channel iron. An apparatus that retains one vehicle tire typically employs a block 5 having the dimensions 3″×1½″×½″ and comprised of steel. The screws employed for an apparatus capable of retaining one vehicle tire typically uses a screw 7 of ¼−20×1″ in conjunction with a lock washer and flat washer.

1. A rack for vehicle lift comprising:
at least one hanging member; and
a support attaching the hanging member to a vehicle lift.

2. The rack for vehicle lift of claim 1, wherein:
the support is comprised of a first L-shaped support having a horizontal segment and a perpendicular vertical segment secured around an opposing second L-shaped support having a vertical segment and a perpendicular horizontal segment and a constricting mechanism for attaching the first L-shaped support and the second L-shaped support around a vehicle lift.

3. The rack for vehicle lift of claim 2, wherein:
the hanging member is the horizontal segment of the first L-shaped support.

4. The rack for vehicle lift of claim 2, wherein:
a block is secured to the horizontal segment of said first L-shaped support.

5. The rack for vehicle lift of claim 4, wherein:
the block is secured by one screw.

6. The rack for vehicle lift of claim 2, wherein:
the first L-shaped support is secured to the second L-shaped support by a plurality of screws.

7. The rack for vehicle lift of claim 6, wherein:
the plurality of screws are flathead screws.

8. The rack for vehicle lift of claim 6, wherein:
said plurality of screws consists of two screws.

9. The rack for vehicle lift of claim 2, wherein:
the constricting mechanism comprises a plurality of holes in different locations along the vertical segment of the first L-shaped support and the vertical segment of the second L-shaped support and the plurality of screws extending through the holes in the desired position.

10. The rack for vehicle lift of claim 9, wherein:
the plurality of screws are flathead screws.

11. The rack for vehicle lift of claim 9, wherein:
said plurality of screws consists of two screws.

12. The rack for vehicle lift of claim 1, wherein:
said support is composed of steel.

13. The rack for vehicle lift of claim 2, wherein:
a vertical post is secured to the hanging member as a retaining means.

14. A rack for vehicle lift comprising:
a hanging member comprised of a first L-shaped member having a horizontal segment and a perpendicular vertical segment;
a second opposing L-shaped member having a vertical segment and a perpendicular horizontal segment secured to the hanging member;
a constricting mechanism for adjusting the distance between the hanging member and the second L-shaped member;

15. The rack for vehicle lift of claim 14, wherein:
the hanging member is comprised of steel.

16. The rack for vehicle lift of claim 14, wherein:
the second L-shaped member is comprised of steel.

17. The rack for vehicle lift of claim 14, wherein:
the constricting mechanism comprises a plurality of holes in different locations along the perpendicular vertical segment of the hanging member and the perpendicular vertical segment of the second L-shaped support and the plurality of screws extending through the holes in the desired position.

18. The rack for vehicle lift of claim 17, wherein:
the plurality of screws are flathead screws.

19. The rack for vehicle lift of claim 17, wherein:
the plurality of screws consists of two screws.

20. The rack for vehicle lift of claim 14, wherein:
a block is secured to the horizontal segment of the hanging member positioned against a vehicle lift.

21. The rack for vehicle lift of claim 20, wherein:
the block is secured by one screw.

22. The rack for vehicle lift of claim 14, wherein:
a vertical post is secured to the horizontal segment of the hanging member as a retaining means.

23. A method for hanging vehicle components, comprising the steps of:
transporting the rack for vehicle lift to a vehicle lift;
securing the rack for vehicle lift to the vehicle lift;
detaching a vehicle component from a vehicle on the vehicle lift;
hanging the vehicle component on the hanging member without extensive lifting or bending; and
reattaching the vehicle component on the vehicle without extensive lifting or bending.
